(19) United States
(12) Patent Application Publication
(10) Pub. No.: US 2007/0195716 A1
(43) Pub. Date: Aug. 23, 2007

(54) Ring bus in an emulation environment

(76) Inventor: Alexandre Richter, Issy Les Moulineaux (FR)

Correspondence Address: KLARQUIST SPARKMAN, LLP, 121 SW SALMON STREET, SUITE 1600, PORTLAND, OR, 97204, US

(21) Appl. No.: 11/517,234

(22) Filed: Sep. 5, 2006

Related U.S. Application Data
(63) Continuation of application No. PCT/EP06/60049, filed on Feb. 17, 2006.

(51) Int. Cl. H04L 12/28

(52) U.S. Cl. 370/258; 370/392

(57) ABSTRACT

A system and method for implementing a ring bus in an emulation environment is disclosed. The ring bus provides an extra communication channel between a ring master node and target nodes on the ring bus for communicating any desired information. In one aspect, the ring bus includes the ring master node and a plurality of target nodes coupled together in series. The first and last target nodes in the series are coupled to the ring master node to form a first communication channel that is a closed loop. The ring bus also includes a plurality of secondary communication channels, separate from the closed loop, connecting, individually, selected target nodes and the ring master node. In another aspect, the secondary communication channels are used as event flags and are a direct connection from the target nodes to the ring master node without traversing other target nodes. When there is a break in the closed loop of the ring bus, for whatever reason, a request can be made for each target node to activate its respective event flag. Such activation is communicated over the secondary communication channels. Using the event flags, the ring master node can determine where in the closed loop there is a break.

### CROSS-REFERENCE TO RELATED APPLICATION

This application is a continuation of copending International Patent Application No. PCT/EP2006/060049, filed on Feb. 17, 2006. This prior application is incorporated by reference herein.

### FIELD OF THE INVENTION

The present invention generally relates to hardware emulators, and more particularly to the use of a ring bus in a hardware emulator.

### BACKGROUND

Today's sophisticated SoC (System on Chip) designs are rapidly evolving and nearly doubling in size with each generation. Indeed, complex designs have nearly exceeded 50 million gates. This complexity, combined with the use of devices in industrial and mission-critical products, has made complete design verification an essential element in the semiconductor development cycle. Ultimately, this means that every chip designer, system integrator, and application software developer must focus on design verification.

Hardware emulation provides an effective way to increase verification productivity, speed up time-to-market, and deliver greater confidence in the final SoC product. Even though individual intellectual property blocks may be exhaustively verified, previously undetected problems appear when the blocks are integrated within the system. Comprehensive system-level verification, as provided by hardware emulation, tests overall system functionality, IP subsystem integrity, specification errors, block-to-block interfaces, boundary cases, and asynchronous clock domain crossings. Although design reuse, intellectual property, and high-performance tools all help by shortening SoC design time, they do not diminish the system verification bottleneck, which consumes 60-70% of the design cycle. As a result, designers can implement a number of system verification strategies in a complementary methodology including software simulation, simulation acceleration, hardware emulation, and rapid prototyping. But, for system-level verification, hardware emulation remains a favorable choice due to superior performance, visibility, flexibility, and accuracy.

A short history of hardware emulation is useful for understanding the emulation environment. Initially, software programs would read a circuit design file and simulate the electrical performance of the circuit very slowly. To speed up the process, special computers were designed to run simulators as fast as possible. IBM's Yorktown “simulator” was the earliest (1982) successful example of this—it used multiple processors running in parallel to run the simulation. Each processor was programmed to mimic a logical operation of the circuit for each cycle and may be reprogrammed in subsequent cycles to mimic a different logical operation. This hardware ‘simulator’ was faster than the current software simulators, but far slower than the end-product ICs. When Field Programmable Gate Arrays (FPGAs) became available in the mid-80's, circuit designers conceived of networking hundreds of FPGAs together in order to map their circuit design onto the FPGAs and the entire FPGA network would mimic, or emulate, the entire circuit. In the early 90's the term “emulation” was used to distinguish reprogrammable hardware that took the form of the design under test (DUT) versus a general purpose computer (or work station) running a software simulation program.

Soon, variations appeared. Custom FPGAs were designed for hardware emulation that included on-chip memory (for DUT memory as well as for debugging), special routing for outputting internal signals, and for efficient networking between logic elements. Another variation used custom IC chips with networked single bit processors (so-called processor based emulation) that processed in parallel and usually assumed a different logic function every cycle.

Physically, a hardware emulator resembles a large server. Racks of large printed circuit boards are connected by backplanes in ways that facilitate a particular network configuration. A workstation connects to the hardware emulator for control, input, and output.

Before the emulator can emulate a DUT, the DUT design must be compiled. That is, the DUT's logic must be converted (synthesized) into code that can program the hardware emulator's logic elements (whether they be processors or FPGAs). Also, the DUT's interconnections must be synthesized into a suitable network that can be programmed into the hardware emulator. The compilation is highly emulator specific and can be time consuming.

In a typical emulator, there are many boards that need to communicate together in order for the system to run smoothly. One technique to effectuate such communication is through a bus structure. Of particular interest to the present invention is a ring bus. In a ring bus, multiple devices (nodes) are connected in a closed loop (also called a ring). Messages on the ring bus pass around the ring sequentially from node to node, generally in one direction. When a node receives a message, it examines the destination address attached to the message. If the address is the same as the node's address, it accepts the message. Otherwise, it regenerates the signal and passes the message along to the next node in the ring.

One obvious problem with a ring bus is that a failure in any connection or device breaks the loop and can take down the entire network. If such a problem occurs, it is difficult to identify where the break in the loop occurred.

Thus, it is desirable to provide a ring bus with an increased ability to detect and overcome any errors in the closed loop.

### SUMMARY

Described below is a system and method for implementing a ring bus in an emulation environment. The ring bus provides an extra communication channel between a ring master node and target nodes on the ring bus for communicating any desired information, such as information pertaining to locating a break in the loop.

In one aspect, a ring master node and a plurality of target nodes are coupled together in series. The first and last target nodes are coupled to the ring master node to form a first communication channel that is a closed loop. A plurality of secondary communication channels, separate from the closed loop, connect, individually, selected target nodes and the ring master node.

In another aspect, the secondary communication channels are used as event flags and are a direct connection from the target nodes to the ring master node without traversing other target nodes. When there is a break in the closed loop of the ring bus, for whatever reason, a request can be made for each target node to activate its respective event flag. Such activation is communicated over the secondary communication channels. Using the event flags, the ring master node can determine where in the closed loop there is a break.

In yet another aspect, the event flags can be used to communicate other information, such as that a target node has a memory capacity problem.

These features and others of the described embodiments will be more readily apparent from the following detailed description, which proceeds with reference to the accompanying drawings.

### BRIEF DESCRIPTION OF THE DRAWINGS

FIG. 1 is a system diagram of a hardware emulator environment including multiple boards coupled together through a midplane.

FIG. 2 is a hardware diagram of a ring bus including a closed loop ring portion and directly connected event flag lines from target nodes to a ring master node.

FIG. 3 is a hardware diagram showing an inter-board ring bus.

FIG. 4 is a detailed hardware diagram of an example ring master node.

FIG. 5 is a flowchart of a method for sending messages on two different communication paths of the ring bus.

FIG. 6 is a hardware diagram showing a break in the ring bus.

FIG. 7 shows a flowchart of a method for finding the break in the ring bus of FIG. 6.

### DETAILED DESCRIPTION

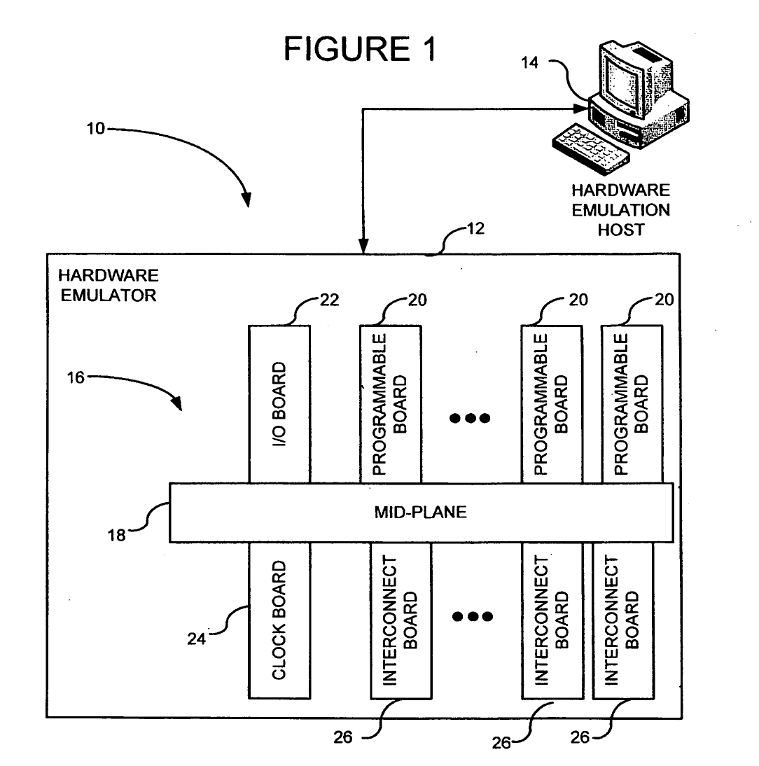

FIG. 1 shows an emulator environment 10 including a hardware emulator 12 coupled to a hardware emulator host 14. The emulator host 14 may be any desired type of computer hardware and generally includes a user interface through which a user can load, compile and download a design to the emulator 12 for emulation.

The emulator 12 includes multiple printed circuit boards 16 coupled to a midplane 18. The midplane 18 allows physical connection of the printed circuit boards into the emulator 12 on both sides of the midplane. A backplane may also be used in place of the midplane, the backplane allowing connection of printed circuit boards on one side of the backplane. Any desired type of printed circuit boards may be used. For example, programmable boards 20 generally include an array of FPGAs, or other programmable circuitry, that may be programmed with the user's design downloaded from the emulator host 14. One or more I/O boards 22 allow communication between the emulator 12 and hardware external to the emulator. For example, the user may have a preexisting processor board that is used in conjunction with the emulator and such a processor board connects to the emulator through I/O board 22. Clock board 24 generates any number of desired clock signals. And interconnect boards 26 allow integrated circuits on the programmable boards 20 to communicate together and with integrated circuits on the I/O boards 22.

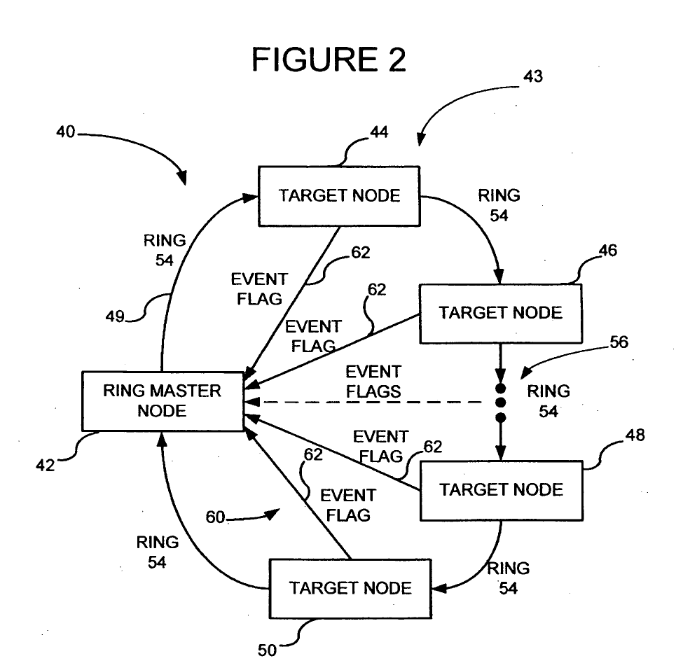

FIG. 2 shows a ring bus 40 used in the hardware emulator 12. As described further below, the ring bus 40 may be used to communicate between boards 16 or between integrated circuits on the same board. A ring master node 42 is coupled to multiple target nodes 43, including target nodes 44, 46, 48, 50, etc., in series in a closed loop 54. The closed loop 54 is the primary communication channel between nodes and is also called a ring. As indicated at 56, any number of target nodes may be included in the ring. Generally, the ring master node 42 sends messages in only one direction as indicated by arrows, such as arrow 49. The message is sent from the ring master node 42 to target node 44 first, which reads the address in the message and determines whether or not to accept the message or pass it onto the next node 46 in the closed loop 54.

The ring bus 40 also has a secondary communication channel 60 that allows communication directly from the target nodes 43 to the ring master node 42 without using the closed loop 54. In particular, an event flag line 62 extends from each target node 43 to the ring master node 42. The illustrated event flag line is a single bit, but multiple-bit lines may also be used based on the particular design needs. The event flag lines 62 have the obvious advantage that if the closed loop 54 is broken, the event flags can still be used as a means of minimal communication with the ring master node 42. This communication channel may be unidirectional or bidirectional, but should at least allow communications from the targets to the ring master node.

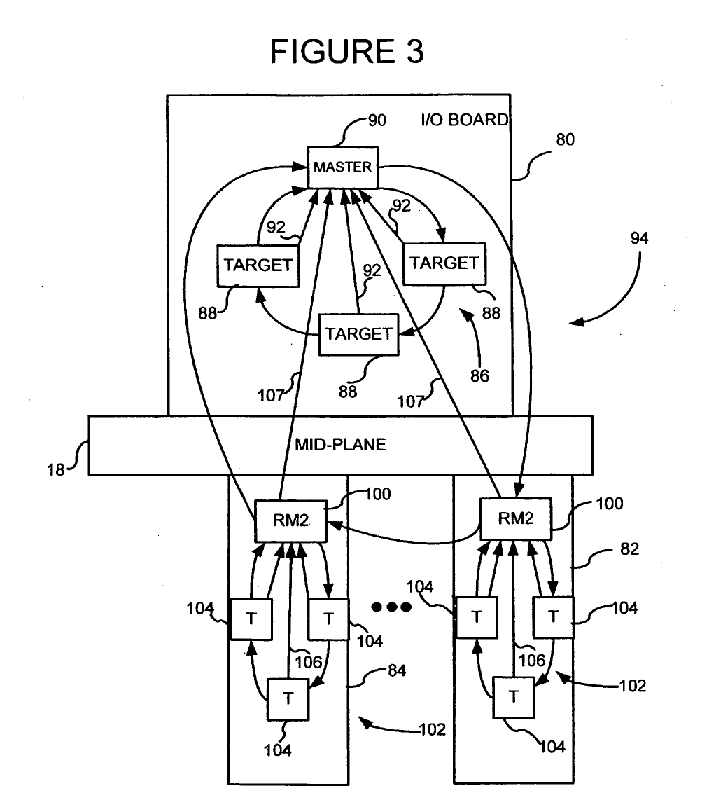

FIG. 3 shows another embodiment of the present invention showing that a ring bus can be located on only one printed circuit board 80 or between multiple printed circuit boards 80, 82, 84. An intra-board ring bus 86 couples together various target nodes 88 in a closed loop to a ring master node 90 as previously described. Each target node 88 is located on the same printed circuit board 80 as the ring master node 90. Additionally, the target nodes 88 have event flag lines 92 coupled to the ring master node 90. At the same time that the ring master node 90 controls the intra-board ring bus 86, it controls an inter-board ring bus 94 that couples multiple boards 80, 82, 84, etc. together. The ring master node 90 communicates with target nodes 100 that act as sub-ring master nodes 100 for their respective boards 82, 84. Each sub-ring master node 100 controls a closed sub-ring 102 with targets 104. Although only three target nodes are shown per board, any desired number may be used. The targets 104 control sub-event flag lines, such as shown at 106. The sub-ring master nodes 100 receive the sub-event flag lines 106 and report the same back to the ring master node 90 via event flag lines 107. In this way, a hierarchical approach is provided with a main ring 94 extending between its board and sub-rings 102 located on other boards to form the ring bus.

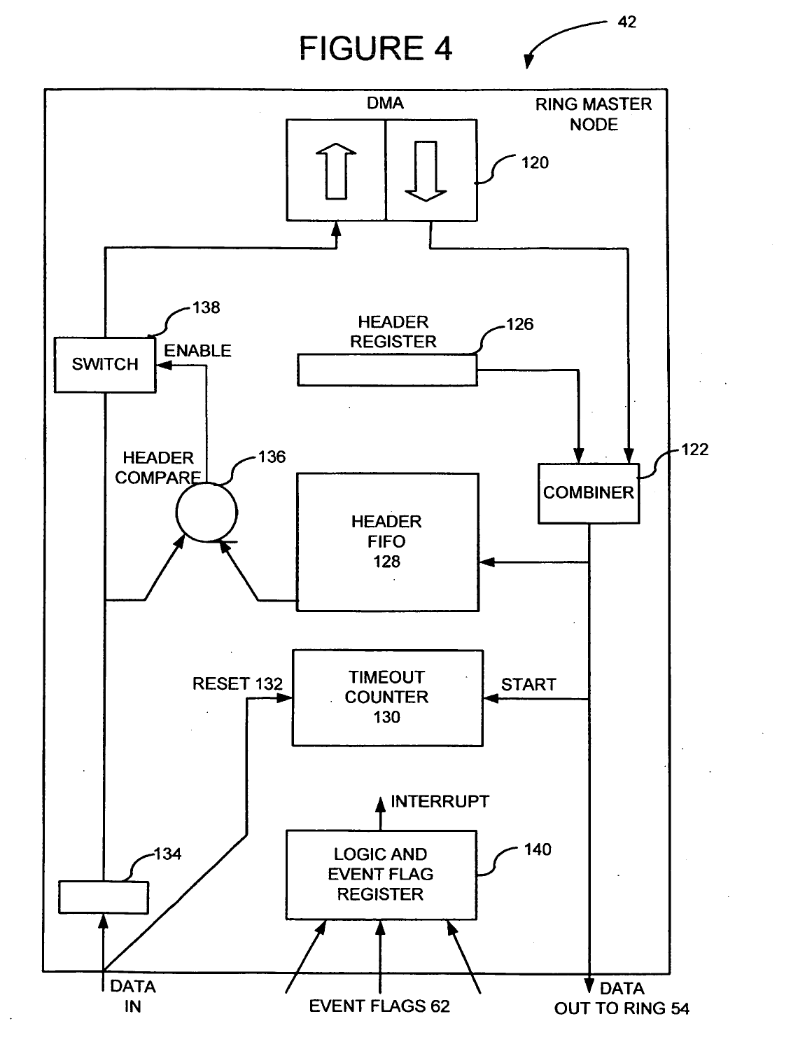

FIG. 4 shows an example design of a ring master node 42. There are many forms that the ring master node may take and the ring master node illustrated is only one such example, and may easily be changed based on the application. A Direct Memory Access (DMA) 120 allows the ring master node to communicate with a memory (not shown) from which stored messages are sent and received messages are stored. The memory is accessible from the emulator host 14 and allows communication between the emulator host and the emulator 12. A combiner 122 is coupled to the DMA 120 and a header register 126 to create a message sent out on the closed loop ring 54. The header information for the message is stored in a header FIFO 128 for later comparison. That is, the message is passed sequentially between the target nodes until it is received back from the last target node in the loop. When the message is sent, a timeout counter 130 is initiated to ensure that if the message is lost, some action is taken. When the message returns to the ring master node, the timeout counter 130 is reset as shown at 132. The message is stored in a buffer 134 and passed to the header compare circuit 136 that compares the header of the incoming message with that stored in the header FIFO 128. If the two headers match, a switch 138 is enabled and the message passes to the DMA 120 and onto memory. The event flag lines 62 are received in register 140. The register 140 has one bit per event flag line. Each bit of the event flag register is ORed together to form an interrupt line. Other logic schemes for combining the bits of the event flag register may also be used. The interrupt line is coupled to a processor (not shown), which can take corrective action. Such a ring master controller 42 can be used on any embodiments described herein.

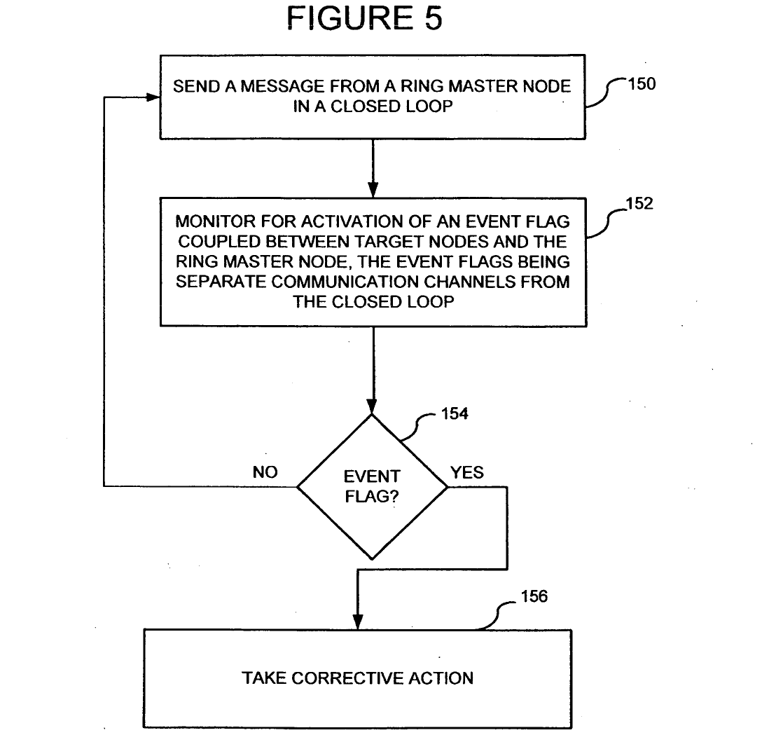

FIG. 5 is a flowchart showing how the ring bus uses event flags. In process block 150, a message is sent to the ring bus on the closed loop in a normal mode of operation. In process block 152, a ring master controller simultaneously monitors two separate channels of communication. The first is the closed loop wherein the ring master controller should receive a message back containing the same header information as that which was sent. The second channel of communication that is monitored is the event flags that are connected between the target nodes and the ring master node. In decision block 154, if an event flag is not detected then the normal mode of operation continues at 150. If an event flag is activated, then an interrupt occurs and corrective action is taken (process block 156). The event flags may be driven in response to a request from the ring master or in response to an internal event within a target node, such as the memory is nearly full.

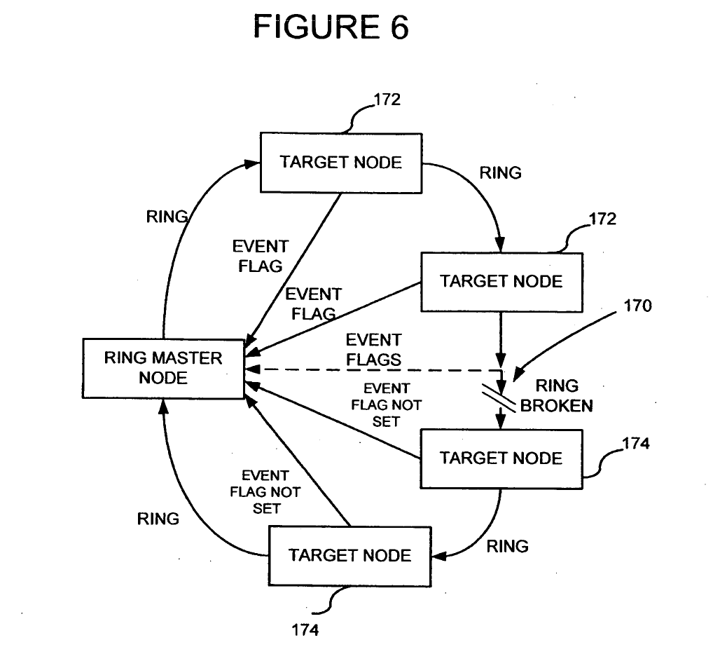

FIG. 6 shows an example of an error situation where the ring 54 is broken as shown at 170. If a timeout in the timeout counter 130 (FIG. 4) occurs, the ring master node 42 sends a broadcast message to all of the target nodes on the ring to set their respective event flag lines. All target nodes 172 before the break 170 receive the message and activate their event flags (i.e., set to a logic high or low depending on the design). However, the target nodes 174 after the break 170 do not receive the message and their event flags are not set. Consequently, it is easy to determine between which two nodes the break occurred.

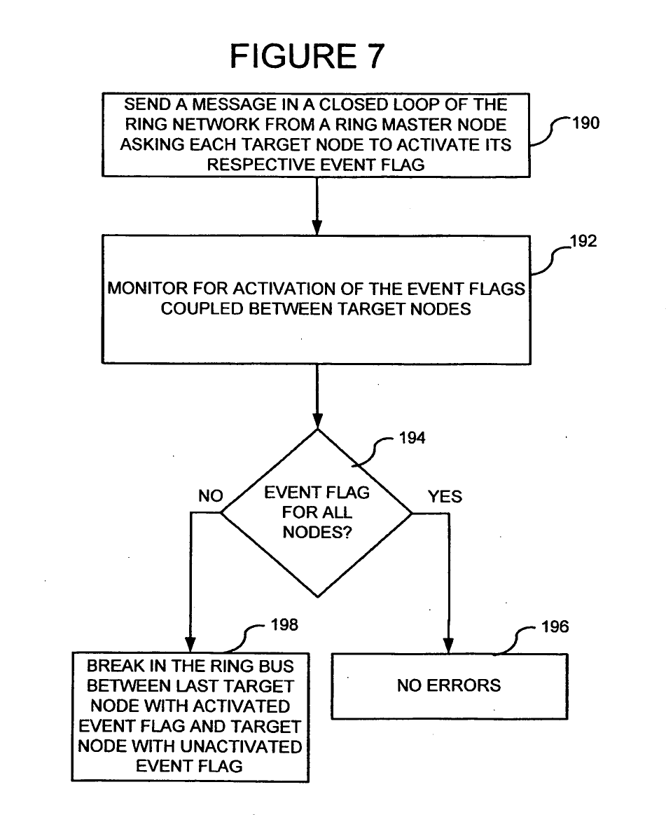

FIG. 7 shows a flowchart of a method for finding a break in the ring of the ring bus. In process block 190, a broadcast message is sent asking each target to set its respective flag. In process block 192, the ring master node monitors the event flag lines in order to see which target nodes received the message. In decision block 194, if the event flag is received from all of the target nodes, then there are no errors as shown in process block 196. Otherwise, a break in the ring is determined by examining the last event flag activated in the ring and/or the first event flag inactivated (process block 198). The break in the ring occurs between these two target nodes.

Having illustrated and described the principles of the illustrated embodiments, it will be apparent to those skilled in the art that the embodiments can be modified in arrangement and detail without departing from such principles.

In view of the many possible embodiments, it will be recognized that the illustrated embodiments include only examples of the invention and should not be taken as a limitation on the scope of the invention. Rather, the invention is defined by the following claims. We therefore claim as the invention all such embodiments that come within the scope of these claims.

We claim:

1. A ring bus in a hardware emulator, comprising:
a ring master node;
a plurality of target nodes coupled together in series, the first and last target nodes in the series coupled to the ring master node to form a first communication channel that is a closed loop; and
a plurality of secondary communication channels, separate from the closed loop, connecting selected target nodes and the ring master node.

2. The ring bus of claim 1, wherein the secondary communication channels are a direct and separate connection from each target node to the ring master node without connection through another target node.

3. The ring bus of claim 1, further including an event flag register within the ring master node that receives a direct connection from each target node using the secondary communication channels.

4. The ring bus of claim 1, wherein the hardware emulator includes multiple printed circuit boards interconnected through a midplane or backplane and wherein the ring master node and the target nodes are located on the same printed circuit board.

5. The ring bus of claim 1, wherein the hardware emulator includes multiple printed circuit boards interconnected through a midplane or backplane and wherein the ring master node is located on a different printed circuit board than the target nodes.

6. The ring bus of claim 5, wherein each target node on a printed circuit board functions as a secondary ring master node for its respective printed circuit board and its respective printed circuit board includes a plurality of secondary target nodes coupled in series.

7. The ring bus of claim 6, wherein the secondary ring master node is coupled directly to the secondary target nodes through a separate communication channel from the closed loop.

8. The ring bus of claim 1, wherein the ring master controller includes an event flag register coupled directly to each target node using the secondary communications channels, and an interrupt signal line coupled to the event flag register that generates an interrupt in response to a communication on the secondary communications channels.

9. The ring bus of claim 1, further including a hardware emulator host coupled to the hardware emulator and the ring master node.

10. The ring bus of claim 1, wherein the first communication channel allows messages to be passed around the closed loop from one target node to another in one direction.

11. The ring bus of claim 1, further including a plurality of programmable logic blocks coupled to an emulator host, the programmable logic blocks for being programmed with a user's design to be emulated.

12. A method of communicating in a ring bus in a hardware emulator, comprising:
sending a message on a closed loop, which includes a plurality of target nodes, in a normal mode of operation by passing the message sequentially between the target nodes; and
monitoring event flag signals coupled to the target nodes in one or more communication channels that are different than the closed loop.

13. The method of claim 12, wherein the normal mode of operation includes:
receiving the message in a first target node;
checking an address of the message;
if the address is the same as the address of the first target node, then accepting the message; and
regenerating the message and sending the message to the next target node in the closed loop.

14. The method of claim 12, further including determining a location of a break in the ring bus by sending a message instructing each target node to activate its respective event flag signals and using the activated event flag signals to determine which is the last target node to receive the message.

15. The method of claim 12, further including generating an interrupt in response to receiving an event flag signal.

16. The method of claim 12, further including programming the hardware emulator to emulate a user's design.

17. A ring bus in a hardware emulator, comprising:
means for communicating from a ring master node to target nodes using a first communications path that forms a closed loop by passing messages sequentially from one target node to the next in the loop; and
means for communicating from a target node to the ring master node by using a second communication path that connects the target node with the ring master node without passing through another target node.

18. The ring bus of claim 17, further including means for connecting each target node in the ring bus directly with the ring master node.

19. The ring bus of claim 17, further including means for interrupting a processor in response to a communication on the second communication path.
